(19) United States
(12) Patent Application Publication
(10) Pub. No.: US 2001/0020847 A1
(43) Pub. Date: Sep. 13, 2001

(54) Method for setting a magnetization of a bias layer of a magnetoresistive sensor element, sensor configuration, and sensor substrate

(76) Inventors: Roland Mattheis, Jena (DE); Hugo Van Den Berg, Herzogenaurach (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/756,083

(22) Filed: Jan. 8, 2001

Related U.S. Application Data
(63) Continuation of application No. PCT/DE99/02017, filed on Jul. 1, 1999.

(30) Foreign Application Priority Data
Jul. 7, 1998 (DE) 198 30 344.0

(51) Int. Cl. G01B 7/30

(52) U.S. Cl. 324/207.21; 324/252; 324/207.25

(57) ABSTRACT

A method for setting the magnetization of at least one bias layer of a magnetoresistive sensor element, the bias layer being part of an artificial antiferromagnetic system including at least one bias layer, at least one flux conducting layer and at least one coupling layer provided therebetween and coupling the two layers antiferromagnetically, includes the steps of heating or cooling the sensor element above or below a predetermined temperature, applying a magnetic setting field during and/or after the heating or cooling, switching off the setting field after a predetermined time, and returning the temperature to the initial temperature. A sensor configuration and a sensor substrate are also provided.

### CROSS-REFERENCE TO RELATED APPLICATION

This application is a continuation of copending International Application No. PCT/DE99/02017, filed Jul. 1, 1999, which designated the United States.

### BACKGROUND OF THE INVENTION

Field of the Invention

The invention relates to a method for setting the magnetization of the bias layer of a magnetoresistive sensor element. The bias layer is part of an AAF system (artificial antiferromagnetic system) including at least one bias layer, a flux conducting layer and a coupling layer provided therebetween and coupling the two layers antiferromagnetically.

Such sensor elements are used, for example, in magnetoresistive angle detectors. The basis of these sensors are the two mutually opposite magnetizations of the bias layer and the flux conducting layer with a strong antiferromagnetic coupling. These two layers behave as a stiff unit which can scarcely be influenced by external fields. By contrast, the magnetic measuring layer is soft-magnetic and its magnetization is aligned parallel with the external field. The angle between the magnetizations in the bias and measuring layers, and thus the resistance of the sensor element, are determined via the external magnetic field. In order to be able to compensate as far as possible for the influence of the temperature on such sensor systems, in which four sensor elements are required for a 180° angle detector and eight sensor elements are required for a 360° angle detector, these sensor elements are connected in the manner of a Wheatstone bridge. It is preferred for the purpose of further-reaching compensation of temperature influences to provide the sensor elements on a common substrate, and to configure them identically as regards layer configuration and layer structure. It is necessary in any case for the magnetization of the bias layers of two elements inside the sensor system including four sensor elements to be opposite to the other two elements. A half-bridge requires only two elements with opposite bias magnetizations. This holds irrespective of whether the sensor system is constructed on a common substrate, or whether it is formed through the use of individual separate sensor elements. It is known for this purpose to apply the respective appropriately directed magnetic field to the individual sensor elements through the use of current-carrying conductors. This requires complicated conductor routing, particularly in the case of sensor elements which are provided on a common substrate and are appropriately connected to and provided with respect to one another. Moreover, the respective setting fields are not uniform for the totality of sensor elements.

### SUMMARY OF THE INVENTION

It is accordingly an object of the invention to provide a method of setting a magnetization which overcomes the above-mentioned disadvantages of the heretofore-known methods of this general type and which provides an alternative to the above-mentioned methods and which allows a simple setting of the bias magnetization of an individual sensor element or of sensor elements of a sensor system.

With the foregoing and other objects in view there is provided, in accordance with the invention, a method for setting a magnetization of at least one bias layer of a magnetoresistive sensor element, the method includes the steps of:

providing a magnetoresistive sensor element having at least one bias layer, the at least one bias layer being part of an artificial antiferromagnetic system including the at least one bias layer, at least one flux conducting layer and at least one coupling layer disposed therebetween and coupling the at least one bias layer and the at least one flux conducting layer antiferromagnetically;

heating or cooling the magnetoresistive sensor element beyond a given temperature;

applying a magnetic setting field during and/or after the step of heating or cooling the magnetoresistive sensor element;

switching off the magnetic setting field after a given time; and

returning a temperature of the magnetoresistive sensor element to an initial temperature.

In other words, in order to solve the object of the invention, a method of the type mentioned above is characterized by the following steps:

a) heating or cooling the sensor element to a predetermined temperature,

b) applying the magnetic setting field during and/or after the heating or cooling,

c) switching off the setting field after a predetermined time, and

d) returning the temperature to the initial temperature.

According to another mode of the invention, at least a further magnetoresistive sensor element having at least a further bias layer is provided; respective magnetizations of the at least one bias layer and of the at least one further bias layer are directed opposite one another; and only the magnetoresistive sensor element is heated or cooled.

According to yet another mode of the invention, a plurality of sensor elements is provided; a magnetization of bias layers of a first group of the sensor elements is directed opposite to a magnetization of bias layers of a second group of the sensor elements; and only the first group of the sensor elements is heated or cooled.

According to another mode of the invention, the given temperature is a first given temperature, and the sensor element and the further sensor element are heated or cooled to a second given temperature prior to the step of heating or cooling the sensor element to the first given temperature; and the second given temperature is maintained for the further sensor element subsequent to the step of cooling or heating the sensor element and the further sensor element to the second given temperature.

According to a further mode of the invention, the given temperature is a first given temperature, and the first group of the sensor elements and the second group of the sensor elements are heated or cooled to a second given temperature prior to the step of heating or cooling the first group of the sensor elements to the first given temperature; and the second given temperature is maintained for the second group of the sensor elements subsequent to the step of cooling or heating the first and second groups of the sensor elements to the second given temperature.

According to another mode of the invention, the sensor elements are provided as sensor bridges on a common substrate for forming angle sensors; and the step of heating or cooling is performed by locally heating or locally cooling.

According to yet another mode of the invention, the angle sensors are 360° angle sensors.

According to a further mode of the invention, the heating is performed by conducting a current in a pulsed manner via the sensor element.

According to yet another mode of the invention, a switching-off time is set for the magnetic setting field earlier in time than an instant at which, during a return to an operating temperature window, a temperature passes through a critical value for which an asymmetry obtained as a consequence of a temperature increase still exists.

According to yet a further mode of the invention, the sensor element is heated to the given temperature, the given temperature being outside and higher than an operating temperature range of the sensor element.

According to another mode of the invention, the sensor element is cooled to the given temperature, the given temperature being outside and below an operating temperature range of the sensor element.

According to another mode of the invention, the sensor element is cooled; and subsequently the sensor element is heated to the given temperature, the given temperature being within an operating temperature range of the sensor element.

According to yet another mode of the invention, the sensor element is cooled; and subsequently the sensor element is heated to the given temperature, the given temperature being outside and higher than an operating temperature range of the sensor element.

Thus, in the method according to the invention the setting is performed in conjunction with a predetermined raised or lowered temperature. The basis for this is that the bias layer and the flux conducting layer and/or the magnetizations thereof have a different temperature response as determined by an asymmetry existing between the layers. If the sensor element is then brought to the predetermined temperature, the saturation magnetization, the coercivity or the anisotropy of one layer varies more strongly than that of the others. As a result of this, after the setting field is switched off the temperature increase given as before aligns the magnetization of the layer in the case of which, for example, the saturation magnetization has changed clearly as a consequence of the temperature variation, in the opposite direction, as will be explained in more detail below. Thus, it is possible to achieve the setting by appropriate temperature control.

The advantages of the method according to the invention are to be seen, in particular, whenever at least two sensor elements, which are to be set simultaneously, are present, in which case the magnetization of the bias layer of the two sensor elements or, in the case of more than two sensor elements, the magnetization of a fraction of the sensor elements is to be directed oppositely to that of the others. In this case, it can be provided according to the invention that only one sensor element or the appropriate fraction of the sensor elements is heated or cooled. As described, there is a change, for example, in the saturation magnetization or in the ratio of the saturation magnetizations of the individual layers only in the case of the heated sensor elements. If the setting field is applied, the magnetization reverses only in the case of the sensor elements influenced by temperature, while the bias magnetization does not reverse in the case of the sensor elements which are not influenced by temperature and in which the saturation magnetization is unchanged. It is, therefore, advantageously possible to operate with a single uniform setting field for setting all the sensor elements. The sensor elements can be heated or cooled locally according to the invention when the several sensor elements are provided on a common substrate in the form of sensor bridges for forming angle sensors, in particular 360° angle sensors.

Although it is possible for the sensor elements not subjected to heat treatment to be kept at room temperature, it is equally possible according to the invention that before the heating or cooling of the sensor element or elements all the sensor elements are cooled or heated and the temperature reached in the process is retained for the subsequent non-heated or non-cooled sensor elements. The selection of the temperature and temperature control depends in the final analysis on the type of sensor elements or the respective layers which are used.

The heating is advantageously performed through the use of currents which are conducted in a pulsed fashion via the sensor element or elements, as a result of which it is possible to achieve local heating with particular advantage in the case of sensor elements provided on a common substrate, something which will be examined further below. The switching-off time for the setting field is to be earlier than the instant at which, during return to the operating temperature, the temperature passes through a critical value for which the asymmetry obtained as a consequence of the temperature increase still exists.

As described, the reversal of the magnetization in accordance with the proposed method is based on the fact that the layers of the treated sensor elements exhibit a different temperature response in the case of the selected setting temperature.

The temperature to which the sensor elements are heated or cooled should expediently be outside and higher or lower than the temperature range within which the sensor element or elements can be operated in order for there to be no reversal of the previously achieved effect upon operation of the sensor elements.

For the case in which the sensor elements are cooled in advance, the subsequent heating temperature of the sensor element or elements can be within the temperature range or outside and higher than the temperature range within which the sensor element or elements can be operated.

In addition to the method according to the invention, the invention relates furthermore to a sensor element or a sensor element system including several sensor elements, the bias layer of the sensor element or elements being set in accordance with the above-described method. In the case of a sensor element system, constructed in this way, with two, three or four sensor elements or a multiple thereof, the four or respectively two, three or four sensor elements can form a Wheatstone bridge.

With the objects of the invention in view there is also provided, a sensor configuration, including:

a magnetoresistive sensor element having an artificial antiferromagnetic system;

the artificial antiferromagnetic system having at least one bias layer with a magnetization set in accordance with the method according to the invention, at least one flux conducting layer, and at least one coupling layer; and

the at least one coupling layer being disposed between the at least one bias layer and the at least one flux conducting layer and coupling the at least one bias layer and the at least one flux conducting layer antiferromagnetically.

According to another feature of the invention, further sensor elements are provided; and the sensor element and the further elements form at least one Wheatstone bridge.

With the objects of the invention in view there is also provided, a sensor configuration, including:

a magnetoresistive sensor element having an artificial antiferromagnetic system;

the artificial antiferromagnetic system having at least one bias layer, at least one flux conducting layer, and at least one coupling layer;

the at least one coupling layer being disposed between the at least one bias layer and the at least one flux conducting layer and coupling the at least one bias layer and the at least one flux conducting layer antiferromagnetically;

the at least one bias layer having a magnetization defined by a magnetic setting field applied to the at least one bias layer during and/or after the magnetoresistive sensor element is in a heated state or a cooled state, the magnetic setting field being switched off after a given time, and a temperature of the magnetoresistive sensor element being returned to an initial temperature.

In addition to the sensor elements or sensor element systems produced using the method according to the invention, the invention further relates to a sensor element itself having at least one bias layer, which is part of an AAF system (artificial antiferromagnetic system) including at least one bias layer, at least one flux conducting layer and at least one coupling layer provided therebetween and coupling the two layers antiferromagnetically, it being possible to set the magnetization of the bias layer through the use of the above-described method in the opposite direction relative to the magnetization of the flux conducting layer. This sensor element is distinguished according to the invention in that the temperature response of the magnetization of the bias layer and of the at least one flux conducting layer differs in a homogeneous magnetic setting field as determined by an asymmetry existing between the layers. As described, the magnetization (coercivity, anisotropy) can be set appropriately as a consequence of the different temperature response of the relevant layers as determined by the asymmetry. In accordance with a first alternative of the invention, this asymmetry can be produced, for example by magnetic moments of different magnitude for the bias layer and the flux conducting layer at the setting temperature. As a consequence of the influence exerted by temperature, there is a change in the ratio of the magnetic moments of the two layers, that is to say at room temperature, for example, the magnetic moment of the bias layer is greater than that of the flux conducting layer, while at the setting temperature the magnetic moment of the bias layer is smaller than that of the flux conducting layer. In addition, the respective Curie temperature of the layers also differs. The different alignment is rendered possible in this case as a consequence of the layer coupling.

Another alternative for producing the asymmetry can reside according to the invention in different thicknesses of the bias layer and the flux conducting layer. Finally, in order to produce asymmetry, according to the invention the bias layer and the flux conducting layer can also have different anisotropies, and in this case the different contribution of anisotropy is the cause in the case of the raised setting temperature. Finally, according to the invention the coercivity, that is to say the magnetic friction within the layers, can differ. A further embodiment according to the invention can provide that the asymmetry is produced through he use of a further ferrimagnetic, ferromagnetic or antiferromagnetic layer coupled to the bias layer or the flux conducting layer. In this case, the bias layer and the flux conducting layer can be identical, since, as a consequence of the coupling of the respective layer to the balancing layer, the respective contribution of asymmetry, for example in the form of the magnetic moments of the balancing layer, or of a possible anisotropy or different coercivity of the same is “added” to the respectively coupled layer. Of course, the bias layer and flux conducting layer can also differ in this case.

According to the invention, the phase transition temperature of the further layer can be lower than the Curie temperature of the bias layer and the flux conducting layer, in which case the bias layer and the flux conducting layer can consist of the same material. As a consequence of the lower Curie temperature, the layer contribution for the layer respectively coupled to the further layer is lacking in the case of a given setting temperature above the Curie temperature of the further layer, and so the asymmetry is set above this temperature.

According to the invention, it is possible to provide two further layers which are coupled to the two flux conducting layers, lying on the outside, in the AAF system and so two flux conducting layers are present here. A further embodiment can be such that the AAF system has two bias layers accommodating the further layer between them.

The sensor element according to the invention is not restricted to a structure with only one AAF system. Rather, according to the invention it is possible to provide two AAF systems which accommodate a decoupled measuring layer between them. In this case, two further layers are provided which are coupled to the flux conducting layers, lying on the outside, of the two AAF systems. The temperature dependence of the magnetization and/or the anisotropy and/or the hysteresis can be so strong that, given a fixed setting field, it is possible to set at least two different bias magnetizations which can be parallel to the setting field, but also be at an angle thereto, specifically whenever the magnetization turns back by a specific angular range after the setting field is switched off.

With the objects of the invention in view there is also provided, a sensor substrate, including:

a plurality of sensor elements having identical layer configurations and being connected as a bridge;

each of the sensor elements having at least one artificial antiferromagnetic system including at least one bias layer, at least one flux conducting layer, and at least one antiferromagnetically coupling layer disposed therebetween;

the at least one bias layer having a first magnetization, the at least one flux conducting layer having a second magnetization directed opposite to the first magnetization, the first magnetization being alignable parallel to a homogeneous magnetic setting field in a first temperature range and opposite to the homogeneous magnetic setting field in a second temperature range;

the first magnetization having a first temperature response in the homogeneous magnetic setting field and the second magnetization having a second temperature response in the homogeneous magnetic setting field, the first temperature response being different from the second temperature response due to an asymmetry between the at least one bias layer and the at least one flux conducting layer; and

the at least one bias layer having a first magnetic moment, the at least one flux conducting layer having a second magnetic moment, the first and second magnetic moments substantially compensating one another in an operating temperature window.

According to another feature of the invention, the first magnetization is set by bringing at least one of the sensor elements in a heated state or a cooled state beyond a given temperature, by applying the homogeneous magnetic setting field during and/or after the at least one of the sensor elements is in the heated state or the cooled state, by switching off the homogeneous magnetic setting field after a given time, and by returning a temperature of the at least one of the sensor elements to an initial temperature.

According to yet another feature of the invention, the first magnetic moment of the at least one bias layer has a first magnitude, the second magnetic moment of the at least one flux conducting layer has a second magnitude different from the first magnitude in order to generate or at least increase the asymmetry at a setting temperature.

According to another feature of the invention, the at least one bias layer has a first layer thickness, the at least one flux conducting layer has a second layer thickness different from the first layer thickness in order to generate or at least increase the asymmetry between the at least one bias layer and the at least one flux conducting layer.

According to yet another feature of the invention, the at least one bias layer has a first anisotropy, the at least one flux conducting layer has a second anisotropy different from the first anisotropy in order to generate or at least increase the asymmetry between the at least one bias layer and the at least one flux conducting layer.

According to a further feature of the invention, the at least one bias layer has a first coercivity, the at least one flux conducting layer has a second coercivity different from the first coercivity in order to generate or at least increase the asymmetry between the at least one bias layer and the at least one flux conducting layer.

According to another feature of the invention, a further layer such as a ferrimagnetic layer, a ferromagnetic layer or an antiferromagnetic layer is provided in order to generate or at least increase the asymmetry between the at least one bias layer and the at least one flux conducting layer; and the further layer is coupled to one of the at least one bias layer and the at least one flux conducting layer.

According to another feature of the invention, the at least one bias layer and the at least one flux conducting layer have respective Curie temperatures; and the further layer has a phase transition temperature lower than the respective Curie temperatures.

According to another feature of the invention, wherein the at least one bias layer and the at least one flux conducting layer are formed of the same material.

According to a further feature of the invention, the at least one flux conducting layer are two outer flux conducting layers provided at an outer region of the at least one artificial antiferromagnetic system; and two further layers each selected from a ferrimagnetic layer, a ferromagnetic layer or an antiferromagnetic layer are coupled to the two outer flux conducting layers.

According to another feature of the invention, the at least one artificial antiferromagnetic system are two artificial antiferromagnetic systems; the at least one flux conducting layer are at least two outer flux conducting layers provided at respective outer regions of the two artificial antiferromagnetic systems; two further layers each selected from a ferrimagnetic layer, a ferromagnetic layer or an antiferromagnetic layer are coupled to the two outer flux conducting layers; and a decoupled measuring layer is provided between the two artificial antiferromagnetic systems.

According to yet another feature of the invention, the at least one bias layer of the at least one artificial antiferromagnetic system are two bias layers; and a further layer selected from a ferrimagnetic layer, a ferromagnetic layer or an antiferromagnetic layer is accommodated between the two bias layers.

According to another feature of the invention, the at least one artificial antiferromagnetic system is configured such that a magnetization, an anisotropy, and/or a hysteresis is a function of a temperature such that at least two different bias magnetizations can be set with a magnetic setting field having a fixed orientation.

According to another feature of the invention, a heating configuration is provided for locally heating at least one of the sensor elements.

According to another feature of the invention, the heating configuration performs a heating with a current flowing via at least one of the sensor elements.

According to another feature of the invention, four of the sensor elements are interconnected to form a sensor bridge; and the heating configuration is configured and disposed such that two of the four sensor elements forming the sensor bridge are heated.

According to another feature of the invention, respective four of the sensor elements are interconnected to form sensor bridges; the heating configuration is configured and disposed such that respective two of the respective four sensor elements forming the sensor bridges are heated; a sensor substrate layer has the sensor bridges disposed thereon; and the heating configuration is interrupted upon separation of the sensor bridges from one another.

According to another feature of the invention, a heating configuration is provided for locally heating at least one of the sensor elements; and the sensor elements and the heating configuration are disposed such that a heating current is conducted via given ones of the sensor elements.

According to another feature of the invention, respective four of the sensor elements are interconnected to form sensor bridges; a heating configuration is provided for locally heating at least one of the sensor elements; and the sensor elements and the heating configuration are disposed such that a heating current is conducted via given ones of the sensor bridges.

According to yet another feature of the invention, four of the sensor elements are interconnected to form a sensor bridge; a heating configuration is provided for locally heating at least one of the sensor elements; and short circuit conductors for short-circuiting two of the four sensor elements of the sensor bridge such that a heating current is conducted via further two, non-short-circuited ones of the four sensor elements.

According to another feature of the invention, the heating configuration is configured as conductors connecting given ones of the sensor elements to be heated; and further ones of the sensor elements, which are not to be heated, have connecting points substantially at an identical potential.

According to a further feature of the invention, at least one voltage equalizing line is provided between two of the conductors.

According to another feature of the invention, the given ones of the sensor elements connected by the conductors are disposed along at least one substantially straight line.

According to yet another feature of the invention, the sensor elements are connected to form a sensor bridge and are disposed in a meandering fashion, respective two of the sensor elements of the sensor bridge are disposed in an interlocking fashion.

According to another feature of the invention, the sensor elements are four sensor elements connected to form a Wheatstone bridge.

According to another feature of the invention, the sensor elements are sets of four sensor elements respectively connected to form Wheatstone bridges.

Finally as described above, the invention relates to a sensor substrate with several sensor elements. According to the invention, the sensor elements are constructed as described above, and a device for locally heating one or more sensor elements are also provided. According to the invention, the device can be such that heating through the use of a current flowing via the sensor element or elements is made possible. If in each case four sensor elements are interconnected to form a sensor bridge, the device for heating can be constructed and provided in such a way that in each case two sensor elements can be heated. If several sensor bridges are provided on the sensor substrate, the device can be constructed in such a way according to the invention that they are interrupted upon separation of the sensor bridges from one another. In this case, the sensor elements and/or the device should expediently be provided such that the heating current is conducted via several, but not all, sensor elements, possibly sensor bridges. An expedient concrete embodiment of the device provides that they are constructed as short-circuit conductors which in each case short circuit two sensor elements of a sensor bridge, it being possible to conduct the heating current via the two non-short-circuited sensor elements to be heated.

As an alternative thereto, it can be provided that the heating device is constructed as conductors connecting the sensor elements to be heated, the sensor elements not to be heated being essentially at the same potential as the sensor elements to be heated. In order in this case largely to avoid that, as a consequence of a possibly existing non-uniform construction of the sensor elements of a sensor bridge, there is a flow of heating current over the sensor elements that are actually not to be heated which lead to them being heated, according to the invention at least one voltage equalizing line can be provided between two conductors serving to heat two sensor elements of a sensor bridge. The sensor elements connected through the use of the conductors should expediently be provided along one or more essentially straight lines. An expedient alternative of the invention provides, by contrast, that the sensor elements of a sensor bridge are constructed in a meandering fashion, two sensor elements being provided in an interlocking fashion in each case. This leads to a better temperature response and a mechanical stress relief of the elements of the respective bridge halves, and this results in a lower bridge offset voltage. If the sensor substrate has four sensor elements or a multiple thereof, that is to say appropriate sensor bridges are present, the four or respective four sensor elements can form a Wheatstone bridge.

Other features which are considered as characteristic for the invention are set forth in the appended claims.

Although the invention is illustrated and described herein as embodied in a method for setting the magnetization of the bias layer of a magnetoresistive sensor element, a sensor element or sensor element system processed in accordance therewith, and a sensor element and sensor substrate suitable for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic plan view of a sensor bridge having four sensor elements of which two can be heated and two are short-circuited;

FIG. 2 is a diagrammatic plan view of a configuration of several sensor bridges on a common substrate;

FIG. 3 is a diagrammatic plan view of a sensor bridge from FIG. 2 after separation of the substrate;

FIG. 4 is a diagrammatic plan view of a sensor bridge of a second embodiment, wherein it is possible to selectively heat two sensor elements;

FIG. 5 is a diagrammatic plan view of several sensor bridges in accordance with FIG. 4 on a common substrate;

FIG. 6 is a diagrammatic plan view of a third embodiment of a sensor bridge;

FIG. 7 is a graph illustrating the control of current, temperature and setting field in accordance with the method according to the invention;

FIG. 8 is a partial, diagrammatic sectional view of a first embodiment of a sensor element;

FIG. 9 is a graph illustrating the temperature dependence of the magnetization of the various layers of the AAF system;

FIG. 10 is a partial, diagrammatic sectional view of a second embodiment of a sensor element;

FIG. 11 is a graph illustrating the temperature dependence of the magnetization of the sensor element of FIG. 10;

FIG. 12 is a partial, diagrammatic sectional view of a third embodiment of a sensor element;

FIG. 13 is a partial, diagrammatic sectional view of a fourth embodiment of a sensor element;

FIG. 14 is a graph illustrating the temperature dependence of the magnetization of the sensor element of FIG. 13;

FIG. 15 is a partial, diagrammatic sectional view of a fifth embodiment of a sensor element;

FIG. 16 is a partial, diagrammatic sectional view of a sixth embodiment of a sensor element;

FIG. 17 is a graph illustrating the temperature dependence of the magnetization of the sensor element of FIG. 16;

FIG. 18 is a partial, diagrammatic sectional view of a seventh embodiment of a sensor element; and

FIG. 19 is a graph illustrating the temperature dependence of the magnetization of the sensor element of FIG. 18.

### DESCRIPTION OF THE PREFERRED EMBODIMENTS

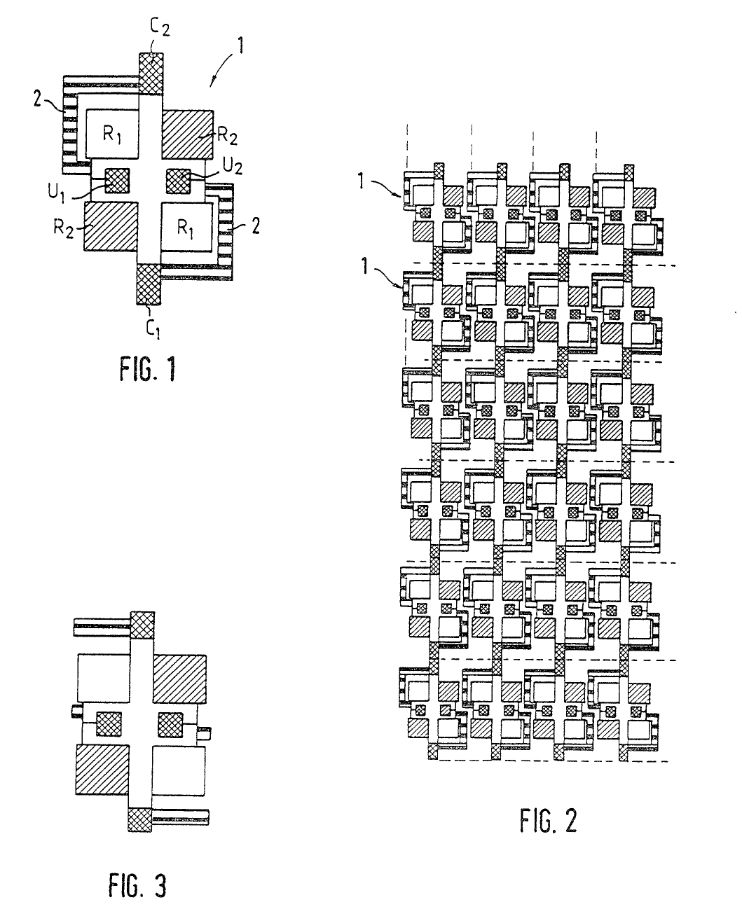

Referring now to the figures of the drawings in detail and first, particularly, to FIG. 1 thereof, there is shown a sensor bridge 1 in the form of a sketch which illustrates the principle of the sensor bridge 1. The sensor bridge 1 includes two sensor elements R₁ and two sensor elements R₂, which are interconnected in the manner of a Wheatstone bridge for the purpose of temperature compensation. As FIG. 2 shows, the sensor bridge is provided on a common substrate, FIG. 2 showing only a sketch of the principle of the bridge configuration. The sensor elements R₂ can be heated selectively in the sensor bridge 1 in accordance with FIG. 1. As FIG. 2 shows, the sensor bridges 1 are provided in series one behind another and interconnected via the respective current pads C1 and C2. A current can be conducted via the sensor elements 1, and this has the result that the sensor elements R₂ are heated as a consequence of the current flow, the sensor elements R₁ are short-circuited via short-circuit conductors 2, thus conducting no heating current or a very weak one, so that they are not heated. The construction of the short-circuit conductors is relatively simple and can be implemented through the use of narrow strip tracks, the more so as the sensor elements mostly include meandering conductor tracks, in order to achieve a desired impedance level. As a consequence of the configuration of the short-circuit conductors 2 and of the configuration of the sensor bridges 1 on the substrate, the short-circuit conductors are interrupted during separation of the individual sensor bridges, compare FIG. 3 in this regard. As an alternative thereto, the short-circuit conductors can also subsequently be etched away.

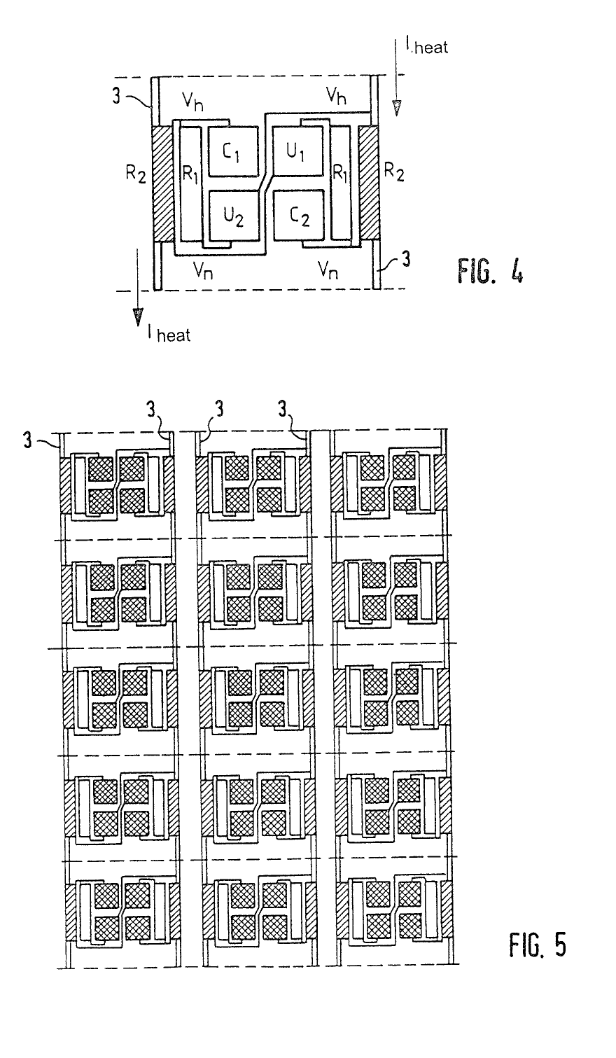

FIGS. 4 and 5 show a further embodiment. The sensor elements and contact pads (C_{1,2}=current pads, U_{1,2}=voltage pads) of the bridge are provided such that the R₂ elements are external and that both the R₂ elements and the R₁ elements are provided on the substrate along straight lines. The R₂ elements are electrically connected in rows on the wafer via conductors 3, each row having a current Iₕₑₐₜ flowing therethrough during setting. The R₁ elements are at the same potential, in principle, as seen in FIG. 4, in accordance with which the R₁ element at the voltage pad U₂ is at potential Vₕ, and the R₁element at the voltage pad U₁ is at potential Vₙ. They therefore conduct virtually no current and are not heated.

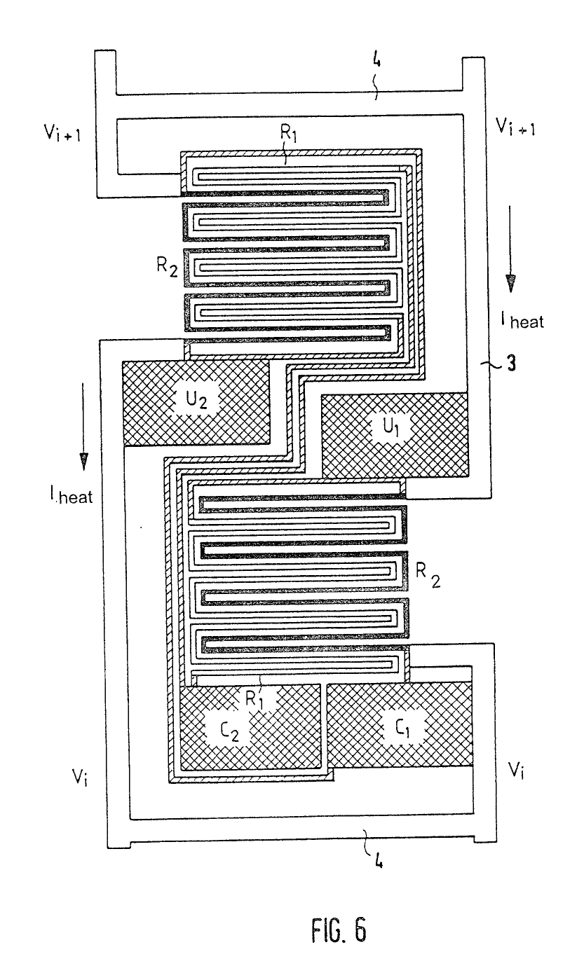

A further advantageous embodiment of a sensor bridge is shown in FIG. 6. The R₁ elements and R₂ elements are of meandering structure, and an R₁ element and an R₂ element interlock in each case inside a bridge half. This “interleaving” leads to a better temperature compensation and to a better mechanical stress relief of the elements, something which results in a smaller bridge offset. In order to reduce still further the already small heating current Iₕₑₐₜ flowing through the R₁ elements, the conductors 3, through the use of which the R₂ elements make electric contact with one another, are connected through the use of voltage equalizing lines 4. The lines 3 and 4 carry potentials Vᵢ and Vᵢ₊₁.

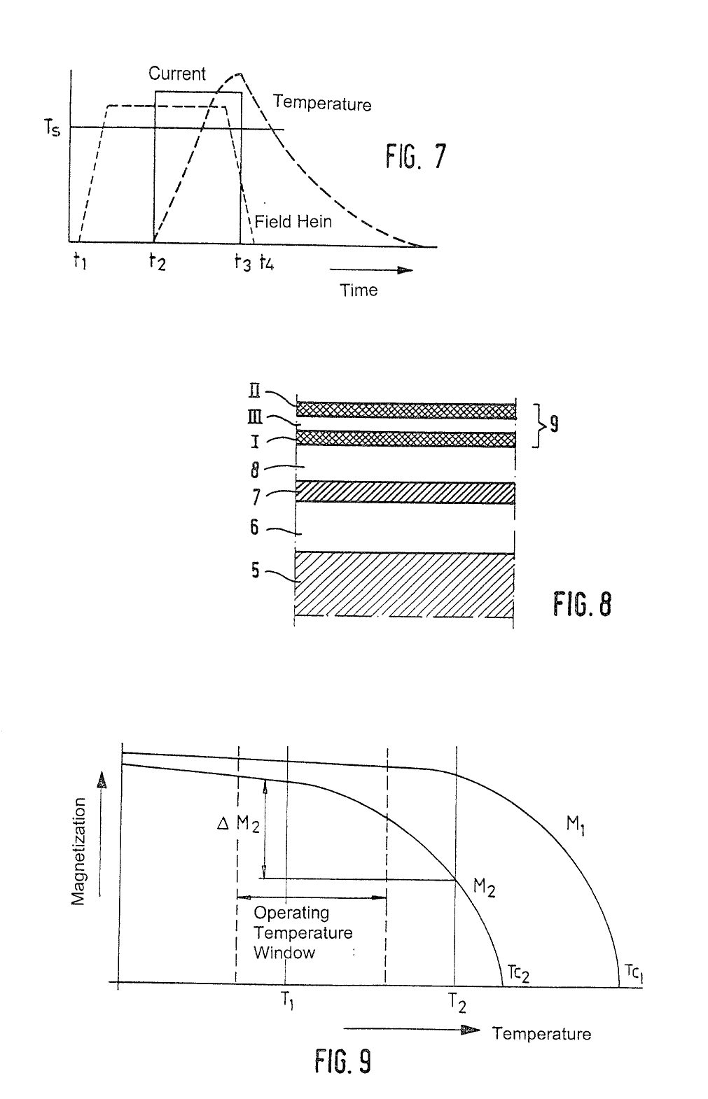

FIG. 7 shows, in the form of a diagram, the principle of the control of current, temperature and setting field. At the instant t₁, the setting field is applied, in a relatively rapidly rising fashion, to the sensor element or elements. Once a maximum has been reached, the field remains constant for a specific time. At the instant t₂, a current pulse is sent via the sensor element or elements, and this leads at the same time to a rise in the temperature of the current-carrying R₂ elements. If the element temperature exceeds a specific temperature T_{S}, the sensor elements R₂ are transferred to another magnetic state. After the field has been switched off, the magnetization in one of these bias layers is aligned opposing the magnetization of the bias layers of the R₁ elements. The setting field is maintained until the temperature is clearly above the temperature Tₛ. The current is switched off at the instant t₃, and this leads to a lowering of the temperature. The setting field has already been lowered previously, and there is no longer any external field at the instant t₄. It is important that the setting is concluded before the temperature drops during the cooling phase below a limiting value, specifically the temperature Tₛ, and the setting field Hₑᵢₙ is below a specific limit. A pulsed characteristic both of the heating current and of the field is required for this purpose. The acceptable duration of the heating depends strongly on the layer configuration, the materials used, material combinations and, above all, on the temperature. The switch-off-time of the setting field Hₑᵢₙ must be clearly shorter than the heating period.

FIG. 8 shows a sketch of the principle of a sensor element. In the exemplary embodiment shown, this sensor element includes the substrate 5, the buffer layer 6, the measuring layer 7, the decoupling layer 8, and the AAF system 9 including the bias layer I, the flux conducting layer II and the antiferromagnetic coupling layer III. As described, the basic idea is to change the magnetic properties of the R₂ elements by a local rise in temperature in such a way that the bias layer magnetizations of the R₁ elements and R₂ elements can be aligned oppositely. Use is made for this purpose of the temperature dependence of the saturation magnetization and/or the coercivity and/or the anisotropy. The elements are to be as constant as possible inside the operating temperature window, that is to say the temperature range within which the sensor element or the bridge is to be operated. That is to say, the setting temperature T₁ or T₂ of either the R₁ elements and/or the R₂ elements is preferably to be either above or below this window. There are two possibilities in principle: either the R₂ elements are heated to temperatures above the operation temperature window, or the entire substrate is strongly cooled and the R₂ elements are heated, in which case the temperature may certainly also be in the operation temperature window, or else above it.

As described, the production of the asymmetry responsible for the different temperature response of the layers I, II is possible with the aid of the magnetic moments of these layers. Starting from the sensor element shown in FIG. 8, it may be assumed that the layer II has a lower Curie temperature Tc₂ than the layer I. It may be assumed that the magnetization of the layer II is parallel to the setting field Hₑᵢₙ. That is to say, M₂>M₁. A reversal of the setting over a local temperature rise can be achieved when the Curie temperature Tc₂ of the layer II is sufficiently low. FIG. 9 illustrates the characteristic of the magnetization as a function of temperature. The low Curie temperature Tc₂ of the layer II has the effect that the saturation magnetization of the R₂ elements is substantially lowered by the value ΔM₂ when the R₂ elements are heated to the setting temperature T₂, the R₁ elements having the lower temperature T₁ (for example room temperature) A reversal occurs when M₂<M₁. Clearly, the magnetizations or the moment distribution between the layers I and II can also be exchanged. Ni-rich alloys are suitable as materials for the layer whose magnetization is to be reversed. It is also possible to use NiFeCo alloys with alloying nonmagnetic elements such as, for example, V, Cr, Pt, Pd and rare-earth metals such as Sm, Tb, Nd etc.

As is to be seen from FIG. 9, furthermore, the setting temperature of the R₁ sensors is inside the operation temperature window. That of the R₂ sensors is above this but still below the Curie temperature of the layer to be processed.

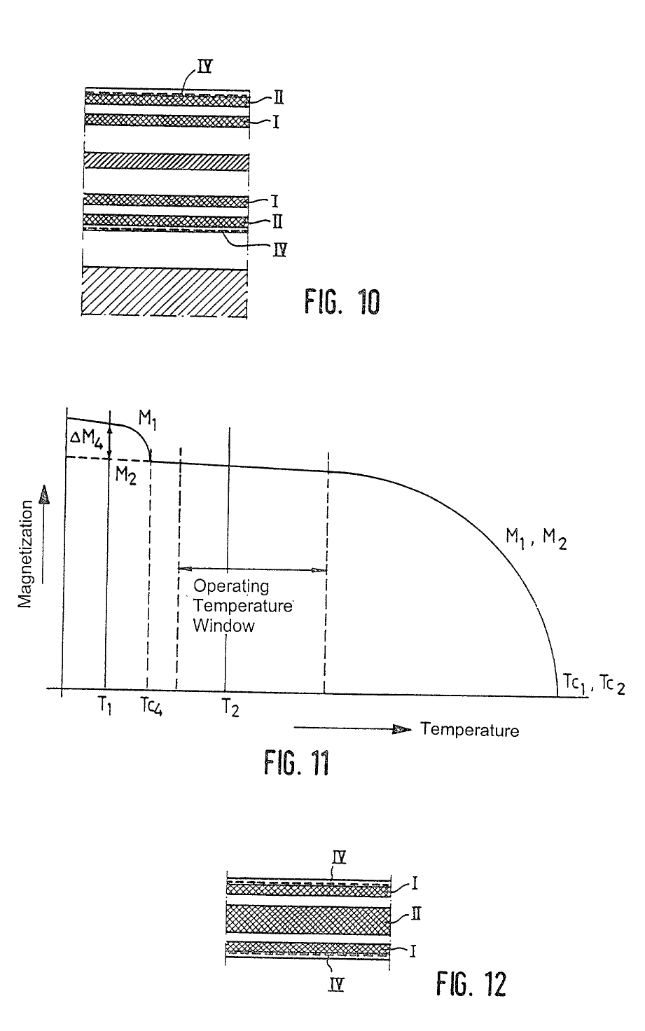

FIG. 10 shows a sensor element with two AAF systems which accommodate a decoupled measuring layer between them. As is to be gathered from the associated FIG. 11, the Curie temperatures of the two layers I, II are identical and high, such that the physical layer parameters are as stable as possible. In the example shown, the layers II are coupled to two further layers IV, so-called balancing layers, that is to say the two magnetizations are coupled. The Curie temperatures of the further layers IV are below the operation temperature window, see FIG. 11. In order to set the R₂ sensors, the entire sensor system is now cooled to a temperature T₁ below the operation window, this temperature still being below the Curie temperature TC₄ of the further layer. As a consequence of the coupling of the layers II to the further layers IV, the magnetic moments of the two layers are aligned ferromagnetically. The effective moment of the respective layer II therefore rises more strongly than the moment of the layer I. Since the R₂ sensors are heated locally to a temperature of above Tc₄ (T₂>Tc₄), the moment of the layer I of the R₂ sensors must be greater than the moment of the layer II at this temperature. This may be seen in FIG. 11 from the resulting difference in magnetization of ΔM₄. This is the contribution caused by the balancing layer. An opposing alignment of the magnetization is also produced here when the ratio of the total moment of the layers I and II to IV of the heated R₂ sensors is reversed.

FIG. 12 shows a further embodiment of a sensor element having a symmetrical AAF system including three magnetic layers. Two further layers IV (balancing layers) are provided on the outside of the AAF system. In addition to the lower temperature loading of this system, it is possible, furthermore, here to implement a sensor element with many periods.

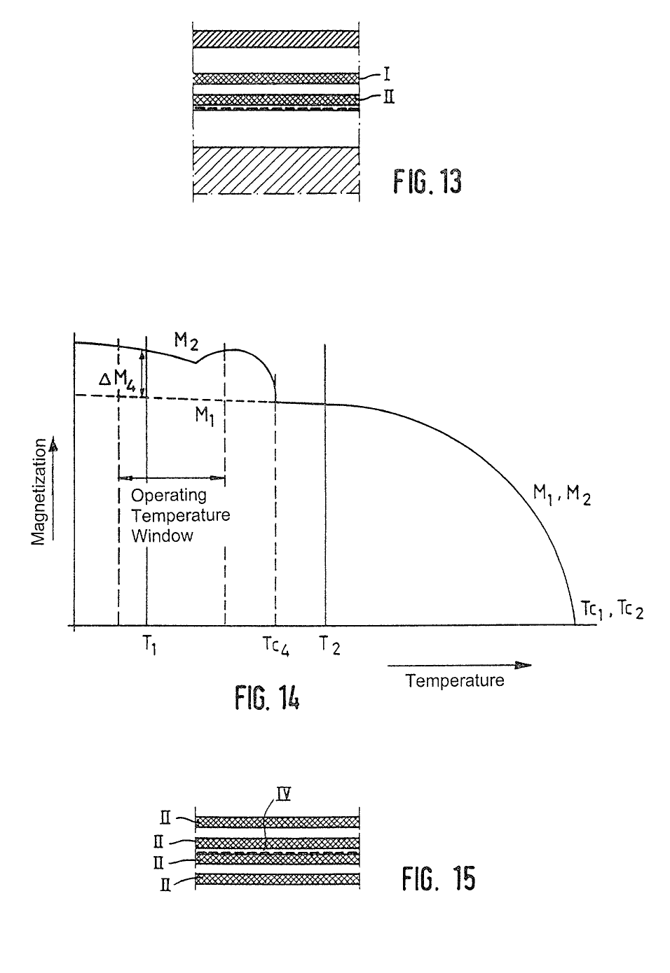

FIGS. 13 and 15 show a further embodiment of a sensor element. The further balancing layer IV coupled there has a Curie temperature Tc₄ above the operation temperature window. The layer is a ferrimagnetic or ferromagnetic layer which is coupled to the layer II of the AAF system. The layers I and II can be formed, in principle, of identical material and have a high Curie temperature. In the case of a ferrimagnetic further layer IV, the layer I of the R₁ sensors has, compare FIG. 14, the greater magnetic moment at the setting temperature T₁ thereof and is parallel to the setting field. The situation is precisely the reverse in the case of the R₂ sensors because of the missing moment of the balancing layer (ΔM₄). As a result thereof, the moment of the layer I is parallel to the setting field in the case of these elements.

FIG. 15 shows a further embodiment of an AAF system including two bias layers and two flux conducting layers provided in a decoupled fashion thereon. The further layer IV is accommodated between the bias layers II, that is to say a single further layer serves here to produce the coupling-induced asymmetry.

As materials for the described layer systems, it is possible to use NiFeCo alloys with additives of nonmagnetic elements such as, for example, V, Cr, Pt, Pd and rare-earth/transition metal alloys such as (FeₓCo₁₋ₓ)_{1-y}X_{y}, where X=, for example, Sm, Tb, Nd, Gd, Dy etc. for the further layer. For the layers of the AAF system, it is possible to use NiFeCo alloys with few alloying constituents or multilayers of these elements.

As an alternative to the above-described production of the required asymmetry, the latter can also be produced via different coercivities or corresponding anisotropies of the relevant magnetic layers of the AAF systems, a combination with the moment variants also being possible. If the bias layer and the flux conducting layer of an AAF system have the same moments, the magnetic friction (coercivity) or the anisotropy of the layers must be selected appropriately for a setting. It may be assumed that the total friction (or anisotropic energy) of the layer II is greater than that of the layer I. It holds in this case that:

τ₂d₂>τ₁d₁,

where τ=rotary friction volumetric density, d=layer thickness,

and, for the anisotropy,

K₂d₂>K₁d₁,

where K=uniaxial anisotropy constant.

Starting from this point, the bias layer magnetization is set up parallel to the setting field when this field is present parallel to the easy direction. During cooling, a further layer IV coupled to the flux conducting layer I will go over from the paramagnetic to the permanently polarized state. This will happen at the Néel temperature in the case of an antiferromagnetic further layer IV. The effective rotary friction or anisotropic energy density of the balancing layer/flux conducting layer combination increases by the absolute value τ₄d₄ or K₄d₄. In the cooled layer combination, the magnetization of the flux conducting layer is aligned parallel to the setting field whenever

τ₂d₂<τ₁d₁+τ₄d₄ or

K₂d₂<K₁d₁+K₄d₄.

For this purpose, the R₂ elements must be heated through the use of the heating current above, for example, the Néel temperature. Here, as well, it is possible to select for the balancing layer a material with a transition temperature above the operation temperature window. The R₁ sensors are then set in the work temperature window, the R₂ sensors above the transition temperature. Materials for the further layer may be antiferromagnetic layers such as:

NiO(500K), CoO(290K), FeMn(530K), FeO(200K), MnO(120K), Cr₂O₃(310K), α-Fe₂O₃(950K), the respective Néel temperature being specified in the brackets.

Ferrimagnetic materials can also be used as balancing layers for controlling the anisotropy and the coercivity. In many rare-earth-rich materials it is easy to produce a uniaxial anistropy via field induction or via magnetoelastic coupling.

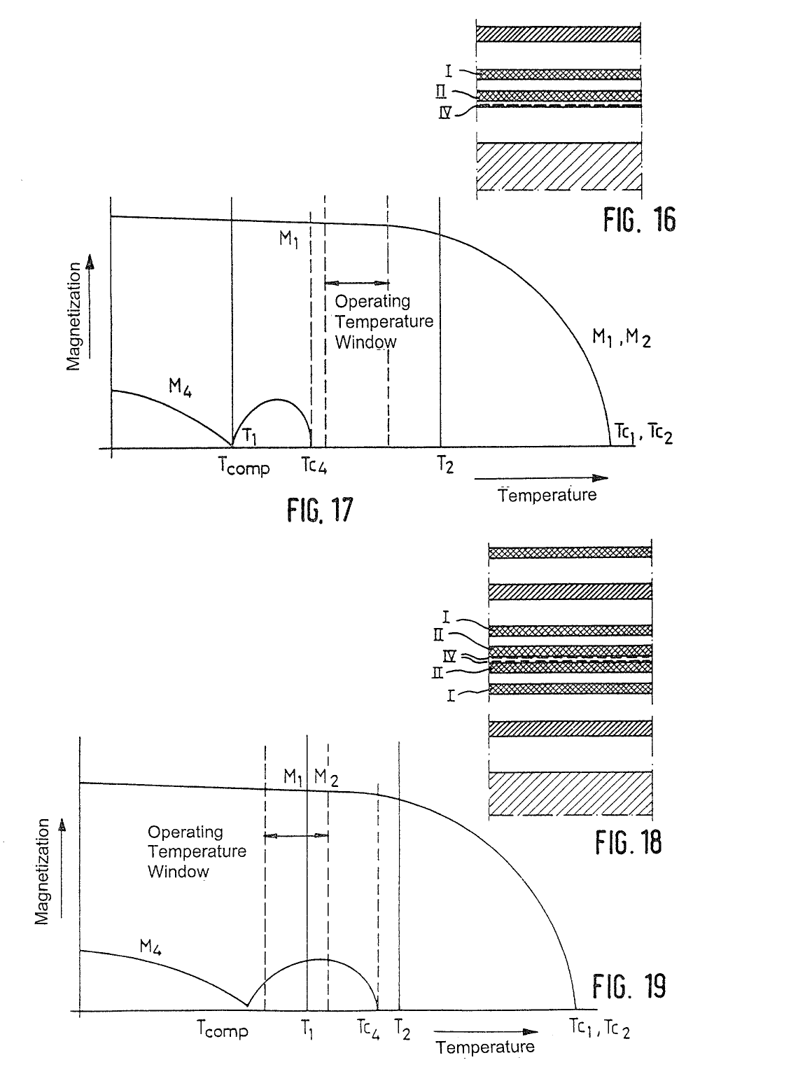

FIG. 16 shows a ferrimagnetic further layer IV with a compensation temperature T_{comp} and a Curie temperature Tc₄ preferably below the operation temperature window, compare FIG. 17. The further layer IV is coupled to the layer II. The setting temperature T₁ of the R₁ sensors is near the compensation temperature and so the magnetic moment contribution of the further balancing layer is virtually zero, while the rotary friction moment increases compared to a layer system without a further layer. A pure control via the coercivity can be implemented in this way. There is also no difficulty with a combination of control by moment and coercivity. The layers I and II consist predominantly of Co, Ni and Fe as carriers of the magnetic moments. If the ferrimagnetic balancing layer medium is a rare-earth/transition metal alloy, the moment of the transition metal, which in this case is coupled ferromagnetically to the layer II, then predominates above the compensation temperature. The moment of the rare-earth element, which is directed opposite to the magnetization of the bias layer II for the heavy rare-earth elements, predominates below the compensation temperature. A decrease in the total magnetization of the combination of layer II and balancing layer reinforces the tendency of layer I to align itself parallel with the setting field.

Finally, FIGS. 18 and 19 show a last embodiment with ferrimagnetic further layers in the middle AAF layers. The moments of the flux conducting layers and the bias layers with coupled balancing layers should preferably compensate one another in the operation temperature window. If, for the purpose of setting the R₂ elements, their setting temperature T₂ is increased above the Curie temperature (TC₄) of the balancing layers IV, both the frictional contribution (or the anisotropy contribution) and the magnetization contribution of the balancing layer vanish. In the case of the R₁ elements held at the temperature T₁, the magnetization of the layer II parallel to the setting field constrains the frictional contribution and/or the anisotropy contribution of the balancing layer. Here, as well, the magnetizations of the bias layers of the R₁ elements and R₂ elements are then directed opposite to the setting field. In the case of this system, rare-earth metal/transition metal alloys such as (FeₓCo₁₋ₓ)_{1-y}X_{y}, where X=, for example, Tb, Gd, Dy, Ho, are recommended as materials for the further layer IV. It is further possible to use oxidic ferrimagnets such as ferrites.

We claim:

1. A method for setting a magnetization of at least one bias layer of a magnetoresistive sensor element, the method which comprises:
providing a magnetoresistive sensor element having at least one bias layer, the at least one bias layer being part of an artificial antiferromagnetic system including the at least one bias layer, at least one flux conducting layer and at least one coupling layer disposed therebetween and coupling the at least one bias layer and the at least one flux conducting layer antiferromagnetically;
one of heating and cooling the magnetoresistive sensor element beyond a given temperature;
applying a magnetic setting field at least one of during and after the step of one of heating and cooling the magnetoresistive sensor element;
switching off the magnetic setting field after a given time; and
returning a temperature of the magnetoresistive sensor element to an initial temperature.

2. The method according to claim 1, which comprises:
providing at least a further magnetoresistive sensor element having at least a further bias layer;
directing respective magnetizations of the at least one bias layer and of the at least one further bias layer opposite one another; and
one of heating and cooling only the magnetoresistive sensor element.

3. The method according to claim 1, which comprises:
providing a plurality of sensor elements;
directing a magnetization of bias layers of a first group of the sensor elements opposite to a magnetization of bias layers of a second group of the sensor elements; and
one of heating and cooling only the first group of the sensor elements.

4. The method according to claim 2, wherein the given temperature is a first given temperature, and comprising: one of cooling and heating the sensor element and the further sensor element to a second given temperature prior to the step of one of heating and cooling the sensor element to the first given temperature; and
maintaining the second given temperature for the further sensor element subsequent to the step of one of cooling and heating the sensor element and the further sensor element to the second given temperature.

5. The method according to claim 3, wherein the given temperature is a first given temperature, and comprising:
one of cooling and heating the first group of the sensor elements and the second group of the sensor elements to a second given temperature prior to the step of one of heating and cooling the first group of the sensor elements to the first given temperature; and
maintaining the second given temperature for the second group of the sensor elements subsequent to the step of one of cooling and heating the first and second groups of the sensor elements to the second given temperature.

6. The method according to claim 3, which comprises:
providing the sensor elements as sensor bridges on a common substrate for forming angle sensors; and
performing the step of one of heating and cooling by one of locally heating and locally cooling.

7. The method according to claim 6, which comprises providing the angle sensors as 360° angle sensors.

8. The method according to claim 1, which comprises performing the heating by conducting a current in a pulsed manner via the sensor element.

9. The method according to claim 1, which comprises setting a switching-off time for the magnetic setting field earlier in time than an instant at which, during a return to an operating temperature window, a temperature passes through a critical value for which an asymmetry obtained as a consequence of a temperature increase still exists.

10. The method according to claim 1, which comprises heating the sensor element to the given temperature, the given temperature being outside and higher than an operating temperature range of the sensor element.

11. The method according to claim 1, which comprises cooling the sensor element to the given temperature, the given temperature being outside and below an operating temperature range of the sensor element.

12. The method according to claim 1, which comprises:
cooling the sensor element; and
subsequently heating the sensor element to the given temperature, the given temperature being within an operating temperature range of the sensor element.

13. The method according to claim 1, which comprises:
cooling the sensor element; and
subsequently heating the sensor element to the given temperature, the given temperature being outside and higher than an operating temperature range of the sensor element.

14. A sensor configuration, comprising:
a magnetoresistive sensor element having an artificial antiferromagnetic system;
said artificial antiferromagnetic system having at least one bias layer with a magnetization set in accordance with the method of claim 1, at least one flux conducting layer, and at least one coupling layer; and
said at least one coupling layer being disposed between said at least one bias layer and said at least one flux conducting layer and coupling said at least one bias layer and said at least one flux conducting layer antiferromagnetically.

15. The sensor configuration according to claim 14, including:
further sensor elements; and
said sensor element and said further elements forming at least one Wheatstone bridge.

16. A sensor configuration, comprising:
a magnetoresistive sensor element having an artificial antiferromagnetic system;
said artificial antiferromagnetic system having at least one bias layer, at least one flux conducting layer, and at least one coupling layer;
said at least one coupling layer being disposed between said at least one bias layer and said at least one flux conducting layer and coupling said at least one bias layer and said at least one flux conducting layer antiferromagnetically; and
said at least one bias layer having a magnetization defined by a magnetic setting field applied to said at least one bias layer at least one of during and after said magnetoresistive sensor element is in one of a heated state and a cooled state, the magnetic setting field being switched off after a given time, and a temperature of the magnetoresistive sensor element being returned to an initial temperature.

17. A sensor substrate, comprising:
a plurality of sensor elements having identical layer configurations and being connected as a bridge;
each of said sensor elements having at least one artificial antiferromagnetic system including at least one bias layer, at least one flux conducting layer, and at least one antiferromagnetically coupling layer disposed therebetween;
said at least one bias layer having a first magnetization, said at least one flux conducting layer having a second magnetization directed opposite to said first magnetization, said first magnetization being alignable parallel to a homogeneous magnetic setting field in a first temperature range and opposite to the homogeneous magnetic setting field in a second temperature range;
said first magnetization having a first temperature response in the homogeneous magnetic setting field and said second magnetization having a second temperature response in the homogeneous magnetic setting field, said first temperature response being different from said second temperature response due to an asymmetry between said at least one bias layer and said at least one flux conducting layer; and
said at least one bias layer having a first magnetic moment, said at least one flux conducting layer having a second magnetic moment, said first and second magnetic moments substantially compensating one another in an operating temperature window.

18. The sensor substrate according to claim 17, wherein said first magnetization is set by bringing at least one of said sensor elements in one of a heated state and a cooled state beyond a given temperature, by applying the homogeneous magnetic setting field at least one of during and after said at least one of said sensor elements is in one of the heated state and the cooled state, by switching off the homogeneous magnetic setting field after a given time, and by returning a temperature of said at least one of said sensor elements to an initial temperature.

19. The sensor substrate according to claim 17, wherein said first magnetic moment of said at least one bias layer has a first magnitude, said second magnetic moment of said at least one flux conducting layer has a second magnitude different from the first magnitude in order to one of generate and at least increase the asymmetry at a setting temperature.

20. The sensor substrate according to claim 17, wherein said at least one bias layer has a first layer thickness, said at least one flux conducting layer has a second layer thickness different from said first layer thickness in order to one of generate and at least increase the asymmetry between said at least one bias layer and said at least one flux conducting layer.

21. The sensor substrate according claim 17, wherein said at least one bias layer has a first anisotropy, said at least one flux conducting layer has a second anisotropy different from said first anisotropy in order to one of generate and at least increase the asymmetry between said at least one bias layer and said at least one flux conducting layer.

22. The sensor substrate according to claim 17, wherein said at least one bias layer has a first coercivity, said at least one flux conducting layer has a second coercivity different from said first coercivity in order to one of generate and at least increase the asymmetry between said at least one bias layer and said at least one flux conducting layer.

23. The sensor substrate according to claim 17, including:
a further layer selected from the group consisting of a ferrimagnetic layer, a ferromagnetic layer, and an antiferromagnetic layer in order to one of generate and at least increase the asymmetry between said at least one bias layer and said at least one flux conducting layer; and
said further layer being coupled to one of said at least one bias layer and said at least one flux conducting layer.

24. The sensor substrate according to claim 23, wherein:
said at least one bias layer and said at least one flux conducting layer have respective Curie temperatures; and
said further layer has a phase transition temperature lower than the respective Curie temperatures.

25. The sensor substrate according to claim 24, wherein said at least one bias layer and said at least one flux conducting layer are formed of a same material.

26. The sensor substrate according to claim 17, wherein:
said at least one flux conducting layer are two outer flux conducting layers provided at an outer region of said at least one artificial antiferromagnetic system; and
two further layers each selected from the group consisting of a ferrimagnetic layer, a ferromagnetic layer, and an antiferromagnetic layer are coupled to said two outer flux conducting layers.

27. The sensor substrate according to claim 17, wherein:
said at least one artificial antiferromagnetic system are two artificial antiferromagnetic systems;
said at least one flux conducting layer are at least two outer flux conducting layers provided at respective outer regions of said two artificial antiferromagnetic systems;
two further layers each selected from the group consisting of a ferrimagnetic layer, a ferromagnetic layer, and an antiferromagnetic layer are coupled to said two outer flux conducting layers; and
a decoupled measuring layer is provided between said two artificial antiferromagnetic systems.

28. The sensor substrate according to claim 17, wherein:
said at least one bias layer of said at least one artificial antiferromagnetic system are two bias layers; and
a further layer selected from the group consisting of a ferrimagnetic layer, a ferromagnetic layer, and an antiferromagnetic layer is accommodated between said two bias layers.

29. The sensor substrate according to claim 17, wherein said at least one artificial antiferromagnetic system is configured such that at least one of a magnetization, an anisotropy, and a hysteresis is a function of a temperature such that at least two different bias magnetizations can be set with a magnetic setting field having a fixed orientation.

30. The sensor substrate according to claims 17, including a heating configuration for locally heating at least one of said sensor elements.

31. The sensor substrate according to claim 30, wherein said heating configuration performs a heating with a current flowing via at least one of said sensor elements.

32. The sensor substrate according to claim 30, wherein:
four of said sensor elements are interconnected to form a sensor bridge; and
said heating configuration is configured and disposed such that two of said four sensor elements forming said sensor bridge are heated.

33. The sensor substrate according to claim 30, wherein:
respective four of said sensor elements are interconnected to form sensor bridges;
said heating configuration is configured and disposed such that respective two of said respective four sensor elements forming said sensor bridges are heated;
a sensor substrate layer has said sensor bridges disposed thereon; and
said heating configuration is interrupted upon separation of said sensor bridges from one another.

34. The sensor substrate according to claim 17, including:
a heating configuration for locally heating at least one of said sensor elements; and
said sensor elements and said heating configuration being disposed such that a heating current is conducted via given ones of said sensor elements.

35. The sensor substrate according to claim 17, wherein:
respective four of said sensor elements are interconnected to form sensor bridges;
a heating configuration is provided for locally heating at least one of said sensor elements; and
said sensor elements and said heating configuration are disposed such that a heating current is conducted via given ones of said sensor bridges.

36. The sensor substrate according to claim 17, wherein:
four of said sensor elements are interconnected to form a sensor bridge;
a heating configuration is provided for locally heating at least one of said sensor elements; and
short circuit conductors for short-circuiting two of said four sensor elements of said sensor bridge such that a heating current is conducted via further two, non-short-circuited ones of said four sensor elements.

37. The sensor substrate according to claim 30, wherein:
said heating configuration is configured as conductors connecting given ones of said sensor elements to be heated; and
further ones of said sensor elements, which are not to be heated, have connecting points substantially at an identical potential.

38. The sensor substrate according to claim 37, including at least one voltage equalizing line provided between two of said conductors.

39. The sensor substrate according to claim 37, wherein said given ones of said sensor elements connected by said conductors are disposed along at least one substantially straight line.

40. The sensor substrate according to claim 17, wherein said sensor elements are connected to form a sensor bridge and are disposed in a meandering fashion, respective two of said sensor elements of said sensor bridge are disposed in an interlocking fashion.

41. The sensor substrate according to claim 17, wherein said sensor elements are four sensor elements connected to form a Wheatstone bridge.

42. The sensor substrate according to claim 17, wherein said sensor elements are sets of four sensor elements respectively connected to form Wheatstone bridges.
